(19) United States
(12) Patent Application Publication
(10) Pub. No.: US 2005/0262133 A1
(43) Pub. Date: Nov. 24, 2005

(54) Multimedia retrieval method using multi-weighted feature

(75) Inventors: Jin-Soo Lee, Seoul (KR); Heon-Jun Kim, Sung-Nam-shi (KR)

Correspondence Address: FLESHNER & KIM, LLP, P.O. Box 221200, Chantilly, VA, 20153-1200, US

(73) Assignee: LG Electronics Inc.

(21) Appl. No.: 11/178,307

(22) Filed: Jul. 12, 2005

Related U.S. Application Data
(63) Continuation of application No. 09/991,866, filed on Nov. 26, 2001, now abandoned.

(30) Foreign Application Priority Data
Nov. 25, 2000 (KR) 2000-70689

(51) Int. Cl. G06F 17/00

(52) U.S. Cl. 707/102

(57) ABSTRACT

A multimedia retrieval method determines a descriptor weight for each of a plurality of descriptors used in a first combination to form a multimedia descriptor query. The method retrieves a group of first multimedia objects based on the descriptor weights corresponding to the first combination of descriptors.

### BACKGROUND OF THE INVENTION

1. Field of the Invention

The present invention relates to a multimedia retrieval method using a plurality of descriptors. In particular, the present invention relates to a multimedia retrieval method providing a more advanced retrieval function using an automatically selected optimum weighted data in accordance with the query descriptor, which has a user-desired format.

2. Background of the Related Art

A multimedia retrieval, including an image retrieval, generally uses combined data with colors, textures or shapes. However, since each multimedia data has a different descriptor for retrieving relevant data, a user can enjoy a far advanced retrieval function using an importance of data regarding the descriptor necessary for retrieving the data, if he or she asks a particular query.

One of the typical multimedia retrieval technologies in the related art uses a user interface through which the user can designate the number of descriptors he or she intends to use for retrieving, every time the user does the multimedia retrieval. The user can perform the multimedia retrieval by designating an importance of each descriptor, for example, 50% for the color and 30% for the texture.

Another example of the multimedia retrieval technology in the related art provides feedback data on an image similar to the image the user is looking for and automatically calculates the weight of the descriptor. However, this method appears to be disadvantageous because the weight is applied only when the user gives feedback for every query.

On the other hand, an attempt recently has been made to standardize the data necessary for retrieving, such as MPEG-7 and so forth. Thus, it has become possible to standardize the weight data on the descriptor and add the standardized data to the multimedia data. In such case, each weight data on the respective data can be applied to a query all the time, regardless of a request of the user, and an advanced retrieval function may be successfully carried out. In this way, a large number of descriptors may be designated in the standardized data since the data designates all kinds of descriptors required within a possible application range. In reality, however, only part of the descriptors can be used for the query and retrieval depending on the application.

For example, the descriptor explaining a video segment can include a variety of semantic data, like the text data, and low-level descriptors like a color histogram. Especially, some low-level descriptors might describe motion data, since video is used for the multimedia in this case. The low-level descriptors may include the descriptors of still images, such as color, texture and shape data because the video image is a collection of still images in a sense.

If the multimedia retrieval is associated with an application for comparing a video segment and other segments, all types of data including motion, color texture, and shape data can be used. However, if the multimedia retrieval is associated with a comparison of the video segment and the still image, the motion data would not be necessary.

Therefore, the descriptors that are actually used in the multimedia retrieval can be different depending on each application. In this case, the relative weight between the descriptors can be altered.

As another example, suppose that the descriptors included in the video segment are color histograms, representative color data, and texture histograms. Further suppose that Application 1 uses all three descriptors while Application 2 uses the color histograms and texture histograms only. Then, in the case of Application 1, the weight on each descriptor of a particular multimedia data can be designated as 0.5, 0.3 and 0.2, respectively, on the condition that all three descriptors (color histograms, representative color data, and texture histograms) are used. Meanwhile, in the case of Application 2, since the color histograms were not used for the same data, the relative weights 0.3 and 0.2 on the remaining two descriptors, i.e., representative color data and the texture histograms are converted and designated to 0.6 and 0.4, respectively.

However, the method described above is not that practical in reality because it is appropriate only when all of the descriptors in the video segment are unrelated and orthogonal to one another. Unfortunately, this is not true in many cases.

That is, unlike the texture histograms, the color histograms and representative color data have a close relationship to each other in terms of color. Therefore, when all three descriptors (color histograms, representative color data and texture histograms) are used as in Application 1, which has two kinds of data on colors (color histograms and representative color data) and one kind of texture data, the color data can be used practically more than expected, compared with Application 2 where only one kind of color data is used.

Suppose that each weight of those three descriptors is 0.5, 0.3, and 0.2, respectively. To use all of three descriptors is similar to using color relevant data (2) and texture relevant data (1) at a ratio of 0.8:0.2 (color:texture).

As described in Application 2, if the representative color data and the texture histograms are combined at the ratio of 0.6:0.4 in terms of the importance, less color data is used compared to the case of using all three descriptors (color: texture=0.8:0.2).

For the reason above, it is better to use all three descriptors than to use two types of descriptors, such as representative color data and texture histograms, for increasing the importance of the representative color data. Thus, in case of using a plurality of combined descriptors, it is possible to apply optimized weights with different ratios from one another according to the combination of each descriptor.

Especially, the weight data in the multimedia data, where different combinations of descriptors are available, should have appropriate and separate weight data in accordance with every possible combination of descriptors, thereby obtaining the results from a highly efficient retrieval.

Going back to the example again, when the multimedia retrieval is carried out based on the combination of the representative color data and the texture histograms, among the color histograms, representative color data, and texture histograms, it is considered that the weight of the combination lies on the color and the texture and the weight of the color data is set to be relatively higher, i.e., 0.8:0.2 or 0.7:0.3. Thus, it is important to have appropriate weight data for each combination of descriptors in order to obtain a more advanced retrieval function.

It is also true that even the identical multimedia data can bring different retrieval results in accordance with an intention of a query. For instance, if the query intends to find an image with a boat, the retrieval might search for any image that has a boat and not necessarily ocean scenery. On the other hand, if the query intends to find an image with ocean scenery, it might end up with any kind of ocean scenery without a boat or the combination of the two is also possible.

Similarly, if the same data is retrieved with a particular query, the result can be varied depending on the kinds of the query (intention, viewpoint). However, if the viewpoint of the query is manifested by different weights, an intended result can be obtained.

Therefore, the multimedia data should have a plurality of weight feature for obtaining an appropriate retrieval result corresponding to a query. Also, the multimedia data should provide a method for automatically selecting the appropriate weight for the viewpoint of the query by figuring out what the user wished to query. The multimedia data should also provide a method for extracting a plurality of weights for the multimedia data.

### SUMMARY OF THE INVENTION

An object of the invention is to solve at least the above problems and/or disadvantages and to provide at least the advantages described hereinafter.

It is, therefore, an object of the present invention to provide a multimedia retrieval method using a multi-weighted feature in order to obtain a more advanced retrieval function.

It is another object of the present invention to provide a multimedia retrieval media for retrieving a multimedia object.

To achieve the above objects, there is provided a multimedia method using a plurality of descriptors for retrieving an object. The method includes studying of a descriptor weight in accordance with a combination of the descriptors, among the plurality of descriptors, for a query and adding the weight to the multimedia descriptor; and retrieving, based on the selected weight corresponding to the combination of descriptors, in accordance with the combination of descriptors for the query at the time of the multimedia retrieval.

Here, the studying of the weight according to the combination of descriptors is made possible through the retrieval result from retrieving images using the combination of the corresponding descriptors or feedback from the user regarding a similar object in connection with group data on any similar objects defined beforehand.

Among other descriptors included in the combination of descriptors above, as the descriptor increases a similarity between similar objects a higher weight is obtained.

Retrieving a selected weight corresponding to the combination of descriptors in accordance with the combination of descriptors for the query, during the multimedia retrieval, further includes measuring a similarity on a similar object the user gave feedback after selecting from the group data on similar objects or the retrieval result, using every weight included in the multimedia descriptors; and retrieving based on the selected weight outputting the highest similarity among other similarities measured.

In the step of retrieving based on the corresponding weight to the combination of descriptors used in the query during the multimedia retrieval, when the user selects a particular descriptor for the retrieval, only the weight studied of the descriptors selected from the plurality of weights included in the multimedia descriptors is used for the retrieval.

Again, in the step of retrieving based on the corresponding weight to the combination of descriptors used in the query during the multimedia retrieval, when the user designates a query object and a retrieval object, only the weight studied of the predesignated descriptors in accordance with the kinds of retrieval object and query object is used for the retrieval.

In addition, for the purpose of retrieving a multimedia object using a plurality of descriptors, the multimedia retrieval method of the present invention includes a descriptor weight studied according to each viewpoint of a query for the retrieval into the multimedia descriptors; and carrying out the retrieval by selecting the corresponding weight to the viewpoint of the query from the descriptor weights included in the multimedia descriptors.

In addition, the multimedia retrieval medium of the present invention has a plurality of descriptors for retrieving the multimedia object; and data features including optimum weight data in accordance with every combination of the descriptors especially for the query among the plurality of descriptors.

Here, the descriptors are combined differently based on the viewpoints of each query and the weights are differentiated depending on the viewpoints of each query also.

Additionally, the objects of the invention may be achieved in whole or in part by a multimedia retrieval method. The method includes determining a descriptor weight for each of a plurality of descriptors used in a first combination to form an multimedia descriptor query and retrieving a group of first multimedia objects based on the descriptor weights corresponding to the first combination of descriptors.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates an extraction algorithm of weight among other studying methods of a weight based on a combination of descriptors, in accordance with a preferred embodiment of the present invention;

FIG. 2 illustrates a modified sigmoid function in order to obtain a reliability which is applied to the present invention;

FIG. 3 illustrates a diagram explaining application examples using multiweight, which is studied differently based on a combination of descriptors, in accordance with another preferred embodiment of the present invention;

FIG. 4 illustrates a display at the result of a query object and response in accordance with another preferred embodiment of the present invention;

FIG. 5 illustrates an extraction algorithm of weight based on a viewpoint of a query in accordance with another preferred embodiment of the present invention;

FIG. 6 illustrates a weight feature, including description data, on a viewpoint of a query in accordance with another preferred embodiment of the present invention;

FIGS. 7a and 7b illustrate diagrams showing an example of a query image and a query viewpoint in accordance with another preferred embodiment of the present invention; and

FIG. 8 illustrates a diagram showing a weight feature, including data on descriptors, in accordance with another preferred embodiment of the present invention.

### DETAILED DESCRIPTION OF PREFERRED EMBODIMENTS

For a better understanding of a multimedia retrieval and a weight studying method, the present invention is divided into four categories: (1) a studying method of multiweight according to a combination of descriptors; (2) an application method of multiweight according to a combination of descriptors; (3) a studying method of multiweight according to a viewpoint of a query; and (4) an application method of multiweight according to a viewpoint of a query.

1. A Studying Method of Multiweight According to Combination of Descriptors

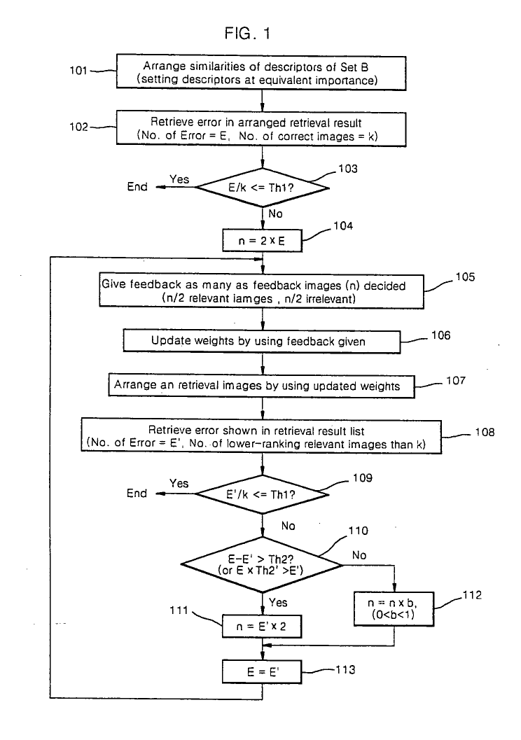

Suppose that a set of the entire descriptors for the multimedia retrieval is Set A=[C1, C2, C3, . . . , CN] and a set of the descriptors used for the combination of current descriptors is Set B=[Ci1, Ci2, Ci3, . . . , CM]⊂Set A. An algorithm for extracting weights for the descriptor set B is explained in FIG. 1.

First of all, each descriptor of Set B, [Ci1, Ci2, Ci3, . . . , CM], is set to have an equivalent importance and the similarities thereof are measured and arranged (S101).

Any type of error in the arranged retrieval result is retrieved and the number of errors is designated as E (S102). In other words, if the number of correct images is k, the error means a lower-ranking image than a high-ranking k regardless of the fact that the error is a correct image as well. The number of errors is set at E.

The correct image data can be obtained through two methods: the user gives feedback on the correct image data in a first retrieval result obtained from step 101; and the images in the same class are collected from a database and grouped beforehand. Later, the correct image data is found using the sample group.

Next, if the error, E (or E/k, wherein E is the number of the error images, E/k is a degree of error from a point of accuracy in percentage), is equal to or below a specific critical value, Th1, the studying method is completed (S103). If the error is not below the critical value described above, the number of images necessary for the feedback is decided using the error E, using the equation n=2×E (S104).

The feedback is then given as many as the number of the feedback images decided before (S105). Here, n number of the error pages having the most errors are arbitrarily selected, among the error pages used in step 102, and are designated as feedback images automatically. The lower the image ranks, the more error exists. A weight for each descriptor is updated based on the feedback given (S106).

Using the updated weights, the image is retrieved again and arranged (S107). Any error shown in the list of the retrieval result is designated as E′ (S108). If the error, E′ (or E′/k), is equal to or below the specific critical value, Th1, the studying method is completed, but if not, it proceeds to the next step (S109).

The degree of decrease in the error is examined to determine whether it exceeds a specific critical value or not (S110). That is, if E-E′ is larger than the specific critical value (Th2) (or E×Th2′>E), the number of feedback images, n, in the following step is determined using the current error E′, such as, n=E′×2 (S111). If E-E′ is not larger than the specific critical value (Th2), the number of feedback images is determined as a smaller number than the previous feedback number, such as, n=n×b, where 0<b<1 (S112).

In case the number of images necessary for the feedback is even smaller than the minimum (it is 2 in the present invention, 2=a similar image 1+a dissimilar image 1), the number of the feedback images is designated as 2.

Lastly, the current E′ is re-designated as E and the studying method goes back to step 105 (S113).

In this way, the weight according to the combination of descriptors, namely the weight for Set B, was extracted and the weight was updated using the feedback images in step 106. The method for updating the weight is explained below.

A new weight (New_W) to be updated is first calculated:
New_{—}W=(Reliability×Old_{—}W+Cur_{—}W)/(Reliability+1) (1)

Wherein, Cur_W is a relative weight calculated based on the feedback given currently. Old_W is a weight before the renewal. Reliability is a value of reliability of the current weight.

Evidently, the reliability indicates the extent to which the weight is reliable. And, the new reliability (New_R) (new Reliability to be updated) can be calculated as follows:
New_{—}R=old_{—}R(1+Increase R)+a (2)
Increase R=f(#feedback)×(Precision(t)−Precision(t−1)), (3)
wherein # feedback is the number provided by feedback, such as the number of relevant images selected by a user in one stage. Old_R is the previous reliability and serves as the value of Reliability in equation (1). Precision (t) is the precision of a result at time t and may be determined by a user's feedback. Preferably, the precision may be calculated as:
   Precision=(the number of relevant images in a rank N)/N, where N has a temporarily defined value.

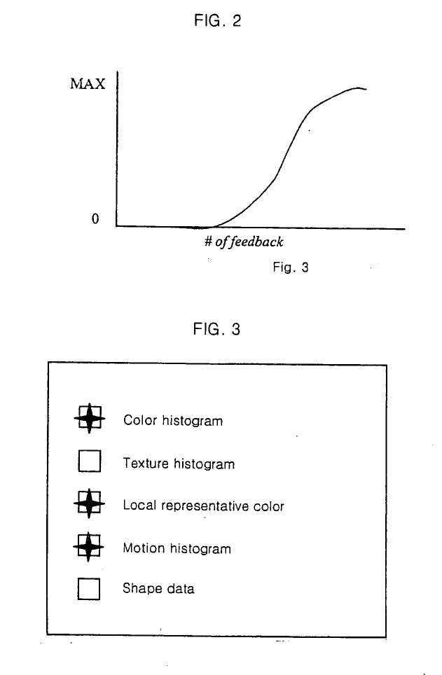

Moreover, if f(# feedback) is small, equation (3) returns an approximate value of 0 and if f gets larger, equation (3) returns an increment. A plot of equation (3) is shown in FIG. 2 and a modified sigmoid function can be used in this case to represent the equation.

As explained before, the relative weight based on the currently given feedback (Cur_W) can be calculated as follows:
Cur_{—}W=a Sim(RI, FI), supposing that FI is a relevant image and
Cur_{—}W=a Dist(RI, FI), supposing that FI is an irrelevant image,
wherein FI is a feedback image; RI is a reference image; W is a type weight (Wk), an element weight (We) or a position weight (Wp); and a is a normalization coefficient for Wk. We and Wp. The relevancy of the retrieved images is preferably determined by the user's feedback.

In addition, Sim (FI, RI) indicates the similarity between the reference image (RI) and the feedback image (FI), in the case of using the descriptors, k, e and p. On the other hand, Dist (FI, RI) indicates the dissimilarity between the reference image (RI) and the feedback image FI), in the case of using the descriptors, k, e and p.

Therefore, when the retrieval is carried out using the combination of descriptors in Set B, the corresponding weight to the image is successfully studied as described above.

Similarly, if there exists another combination of descriptors, Set C, appropriate weights can be retrieved and studied using the descriptors included in Set C. At this time, the dimension of a weight for each descriptor is the same as the number of constituents in the Set.

2. Application Method of Multiweight According to Combination of Descriptors

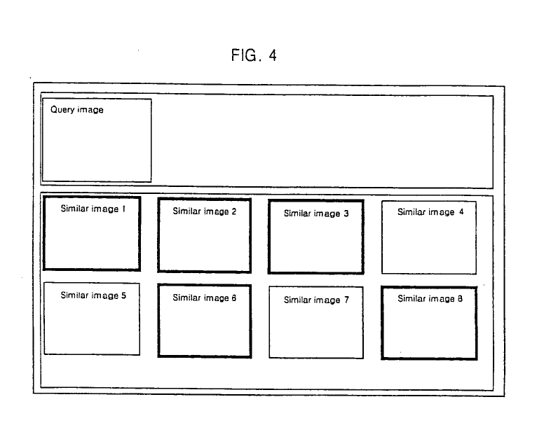

As explained before, differently studied multiweight according to each combination of descriptors can be applied to other cases. To begin with, the user can select a descriptor for the multimedia retrieval using a user interface, as shown in FIG. 3. Particularly in FIG. 3, color histograms, representative color data, and motion histograms are selected, for example, out of five descriptors (color histograms, texture histograms, representative color data, motion histograms, and shape data). Once the user selects descriptors necessary for the multimedia retrieval using the user interface, the weights thereof are automatically selected for the retrieval, based on the method explained with reference to FIG. 1 and according to the combination of descriptors selected.

A method of selecting a weight out of a plurality of weights, based on the study on the selected descriptors only, is now explained below.

The weight feature includes each weight and data showing which weight goes with which descriptor. Based on the aforementioned data, it becomes possible to find out which weight of a descriptor is included in the current weight and the descriptors, represented by the weights included, select the weights corresponding to the descriptors selected.

Another method of selecting multiweight is that the user selects a similar object to what he or she intended to find from the early retrieval result. As for the similar object selected, the similarity is measured using a respective weight that is studied according to the combination of descriptors and the weight outputting the result, based on the highest similarity, is selected.

If the multimedia object already contains data on an example of the objects belonging to the similar class, the retrieval method displays the identical class object with the query object (in this case, it is an image), as shown in FIG. 4, and helps the user to select the object he or she intended to find. In other words, the method displays the identical class image with the query image, as the similar image, and makes it possible for the user to select the image he or she wanted.

The similar image surrounded by a bold rectangle in FIG. 4 is the object the user selected as the similar image. Once the object is selected, the similarity between the similar image selected by the user and the query image is measured using each studied weight, in accordance with the combination of descriptors, and the weight outputting the highest similarity is selected.

Also, the weight can be selected by different kinds of queries that are designated in advance. For example, the queries can be divided into several kinds, e.g., video and video retrieval, or video and still image retrieval. The descriptors for each case are determined and the corresponding weights are designated in order to select the appropriate weight, in accordance with the kind of the query of the user.

The kind of query the user asked can be determined once a query object and a retrieval object are determined. For instance, in the case that the kind of the query is a video segment and the retrieval object is an image database, the retrieval identifies video and still images.

3. Studying Method of Multiweight According to Viewpoint of Query

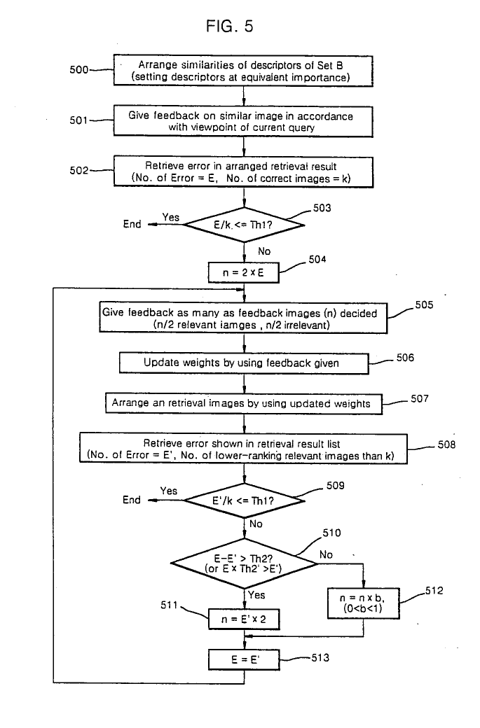

FIG. 5 illustrates an example explaining the algorithm for extracting the weight in accordance with the viewpoint of a particular query. First of all, the descriptors in possession are set at an equivalent importance and the similarity thereof is measured and arranged later (S500). Next, the user gives feedback on the similar image, corresponding to the viewpoint of the current query, in the early retrieval result (S501). In the following steps, the similar image from the feedback is considered as the correct answer and the studying is proceeded from there.

Especially in steps of 500 and 501, the data on the correct answer according to the viewpoint of the particular query was retrieved based on the feedback given by the user from the early retrieval result. If every object contains the data on image examples belonging to the same class, instead of carrying out the early retrieval as in step 500, the image examples belonging to the same class are displayed first and the user can select the similar image among the displayed images.

Beginning with step S502, the same procedure as that of FIG. 1, beginning with step 102, is repeated here. That is, the number of errors, E, is designated by retrieving any error in the arranged retrieval result (S502). If the error E (or E/k) is equal to or below the specific critical value, Th1, the studying method is completed. If not, the number of images necessary for the feedback (n=2×E) is decided using the error E (S503 and S504). The feedback is given as many as the number of images, n, in accordance with the method described above (S505).

After that, a weight of each descriptor is updated using the feedback given (S506) and, based on the updated weight, the image is retrieved again and arranged (S507). Another error, E′, is designated after retrieving the error shown in the list of the retrieval result (S508). Here, if E′ (or E′/k) is equal to or below the specific critical value, Th1, the method is completed, but if not, the next step proceeds (S509).

The degree of decrease in the error is examined to determine whether or not it exceeds the specific critical value, Th2, (S510). Based on the result obtained here, the number of images, n, necessary for the feedback is determined (n=E′×2) using the current error E′ (S511). Otherwise, the number of images for the feedback can be decided to be smaller than the number of the previous feedback (n=n×b, 0<b<1) in the next step S512. After re-designating the current error (E′) as E, step S505 is repeated (S513).

4. Application Method of Multiweight According to Viewpoint of Query

As explained before, differently studied multiweight according to each combination of descriptors can be applied to other cases. In the beginning, the user selects the similar object to the object he or she intended to find in the early retrieval result. As for the similar object selected, the similarity is measured using the respective weight that is studied according to the combination of descriptors and the weight outputting the result based on the highest similarity is selected.

If the multimedia object already contains data on an example of the objects belonging to the similar class, the retrieval method displays the identical class object with the query object, as shown in FIG. 4, and helps the user to select the object he or she intended to find. Once the object is selected, the similarity is measured using each weight and the weight appropriate for the corresponding viewpoint of the query outputting the result of the highest similarity is selected.

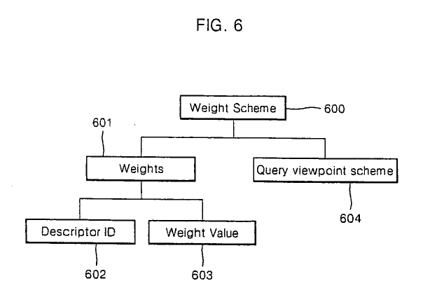

FIG. 6 shows an example of the weight feature, which contains a weight scheme for the viewpoint of the query. The weight scheme 600 is comprised of a descriptor ID 602, for describing weights 601, the corresponding weight value 603, and scheme of the viewpoint for the query 604. If the viewpoint of the corresponding query in the weight feature is described in text, as shown in FIG. 6, this also can be applied.

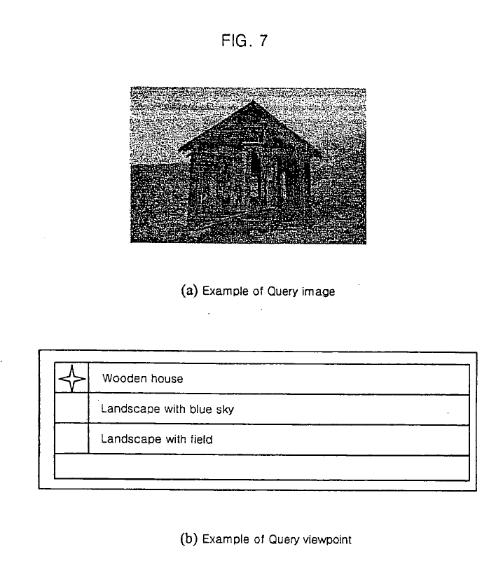

In other words, the viewpoints of the queries of existing weights (especially the viewpoints of the queries described in text) are arranged, as shown in FIG. 7b, to be selected by the user. Particularly, FIG. 7a illustrates an image of landscape including a house, where the viewpoint of the query can be things like a house, a blue sky, or a field.

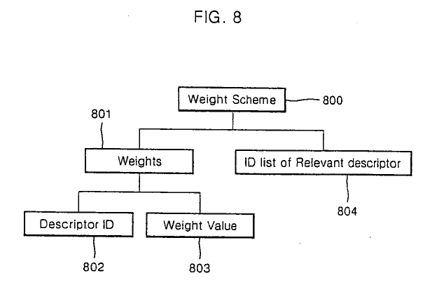

On the other hand, FIG. 8 shows a weight feature containing data on the combination of descriptors. The weight scheme 800 is comprised of a descriptor ID 802, for describing weights 801, the corresponding weight value 803, and a list of associated descriptors 604.

Using the weight feature containing data on the combination of descriptors, it becomes easier to select an appropriate weight through an immediate use of the data.

Until now, a multi-weight feature according to the viewpoint of the query and the multi-weighted feature according to the combination of descriptors have been explained.

Therefore, using the multi-weighted feature according to the combination of descriptors and the multi-weighted feature according to the viewpoint of the query, the corresponding weight can be automatically selected and used despite the fact that each weight feature does not necessary have data on the combination of the descriptors or the viewpoint of the query itself.

However, if each weight feature contains data on the combination of descriptors currently used for the weight, as shown in FIG. 8, or the viewpoint of the query is described in each weight feature, as shown in FIG. 6, it is much easier to select an appropriate weight using the data immediately.

In such case, although a more easy application is possible, the same can be regarded defective in terms of the size of data since additional data are required.

As explained hitherto, the multimedia retrieval method of the present invention enables a far advanced retrieval function by providing each object with the optimum descriptor weight that is appropriate for a variety of applications. In addition, the present invention enables the user to carry out different retrievals according to different viewpoints even on the same object, by extracting an optimum weight for the viewpoint of the query the user asks, thereby making it come true of the user-centered retrieval.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

1. A multimedia retrieval method, comprising:
providing multimedia data having a multimedia descriptor including a designated set of descriptors;
determining a descriptor weight in accordance with a combination of descriptors for each descriptor of at least one subset of the designated set of descriptors, based upon a relation between at least one descriptor of the at least one subset and at least one descriptor of the designated set of descriptors that is not included in the at least one subset;
associating the descriptor weight to the multimedia descriptor; and
retrieving a multimedia object based on a selected weight corresponding to the combination of descriptors for a query.

2. The method of claim 1, wherein determining the descriptor weight is accomplished through a prior retrieval result of retrieving images, using the combination of descriptors, or a feedback given by a user regarding a similar object in connection with group data on any similar objects defined in advance.

3. The method of claim 2, wherein descriptors that identify increasing similarity between the similar objects are provided increasingly higher descriptor weights.

4. The method of claim 2, further comprising:
measuring a similarity on the similar object, for which the user gave feedback, or the prior retrieval result using every descriptor weight included in the multimedia descriptor; and
retrieving the multimedia object based on the selected weight outputting a highest similarity.

5. The method of claim 1, wherein if a user selects a particular descriptor for the retrieval, only the descriptor weight of the particular descriptor selected, from the combination of descriptors included in the multimedia descriptor, is used for the retrieval.

6. The method of claim 1, wherein if a user designates a query object and a retrieval object, only the combination of descriptors corresponding with the retrieval object and the query object is used for the retrieval.

7. A multimedia retrieval method, comprising:
determining a descriptor weight in accordance with a viewpoint of a query for the multimedia retrieval;
associating the descriptor weight to a multimedia descriptor; and
retrieving a multimedia object based on a selected weight corresponding to the viewpoint of the query, among other descriptor weights included in the multimedia descriptor.

8. The method of claim 7, wherein determining the descriptor weight is accomplished through a prior retrieval result from retrieving images or feedback given by a user regarding a similar object, in connection with group data on any similar objects defined in advance.

9. The method of claim 8, wherein a descriptor that identifies increasing similarity between the similar objects is provided a higher descriptor weight.

10. The method of claim 8, further comprising:
measuring a similarity on the similar object, for which the user gave feedback, or the prior retrieval result using every descriptor weight included in the multimedia descriptor, and
retrieving the multimedia object based on the selected weight outputting a highest similarity.

11. The method of claim 7, further comprising:
displaying a particular viewpoint of the query, among other viewpoints of the query; and
retrieving the multimedia object based on the particular viewpoint of the query selected by a user.

12. A multimedia retrieval method, comprising:
determining a descriptor weight for each of a plurality of descriptors used in a first combination to form a multimedia descriptor query, based upon a relation between at least one of the descriptors in the first combination and at least one descriptor of a designated set of descriptors of the multimedia descriptor that is not in the first combination; and
retrieving a group of first multimedia objects based on the descriptor weights corresponding to the first combination of descriptors.

13. The multimedia retrieval method of claim 12, further comprising:
determining the descriptor weight for each of a plurality of descriptors used in a second combination to form a subsequent multimedia descriptor query; and
retrieving a group of second multimedia objects based on the descriptor weights corresponding to the second combination of descriptors, wherein the group of second multimedia objects has a higher correlation to a desired multimedia object than the group of first multimedia objects.

14. The multimedia retrieval method of claim 13, wherein:
the descriptor weights for the plurality of descriptors used in the second combination distinguish a particular multimedia object selected from the group of first multimedia objects from all other multimedia objects within the group of first multimedia objects.

15. The multimedia retrieval method of claim 13, wherein:
the descriptor weights for the plurality of descriptors used in the second combination distinguish a particular multimedia feature selected from a group of features associated with the group of first multimedia objects from all other multimedia objects within the group of first multimedia objects.

16. The multimedia retrieval method of claim 14, further comprising:
(a) replacing the first combination of descriptors and associated descriptor weights with the second combination of descriptors and associated descriptor weights;
(b) replacing the group of first multimedia objects with the group of second multimedia objects;
(c) determining the descriptor weight for each of the plurality of descriptors used in a new determination of the second combination to form the subsequent multimedia descriptor query, based on the particular multimedia object selected by a user from the group of first multimedia objects; and
(d) retrieving the group of second multimedia objects based on the descriptor weights corresponding to the second combination of descriptors; and
repeating steps (a) through (d) in sequence until the group of second multimedia objects reaches a predetermined level of correlation with a desired multimedia object.

17. The multimedia retrieval method of claim 15, further comprising:
(a) replacing the first combination of descriptors and associated descriptor weights with the second combination of descriptors and associated descriptor weights;
(b) replacing the group of first multimedia objects with the group of second multimedia objects;
(c) determining the descriptor weight for each of the plurality of descriptors used in a new determination of the second combination to form the subsequent multimedia descriptor query, based on the particular multimedia feature selected by a user from the group of first multimedia objects; and
(d) retrieving the group of second multimedia objects based on the descriptor weights corresponding to the second combination of descriptors; and
repeating steps (a) through (d) in sequence until the group of second multimedia objects reaches a predetermined level of correlation with a desired multimedia object.

18. The multimedia retrieval method of claim 15, wherein:
the group of features associated with the group of first multimedia objects is identified by a tabulation of textual descriptions of the features.

19. The multimedia retrieval method of claim 15, wherein:
the group of features associated with the group of first multimedia objects is identified by a tabulation of mathematical representations of the features.
